(19) United States
(12) Patent Application Publication
(10) Pub. No.: US 2023/0173928 A1
(43) Pub. Date: Jun. 8, 2023

(54) Photovoltaic Charging System for an Electric Vehicle Internal Battery

(71) Applicant: George F. White, III, Charlestown, RI (US)

(72) Inventor: George F. White, III, Charlestown, RI (US)

(21) Appl. No.: 17/896,415

(22) Filed: Aug. 26, 2022

Related U.S. Application Data
(60) Provisional application No. 63/285,703, filed on Dec. 3, 2021.

(51) Int. Cl. B60L 8/00; B60L 53/51; H02S 10/40; H02S 10/20; H02S 40/38; H02J 7/35

(52) U.S. Cl. CPC B60L 8/003; B60L 53/51; H02S 10/40; H02S 10/20; H02S 40/38; H02J 7/35

(57) ABSTRACT

The present invention relates to a photovoltaic electric vehicle charging system configured to recharge an internal battery of the electric vehicle for increasing range of the vehicle and for reducing frequency of visits to charging stations for charging the battery. In other embodiments, the system can be used for directly providing power to an HVAC system, a refrigeration system, and more, of the vehicles. More specifically, the system includes a set of solar panels integrated or retrofitted on an exterior surface of the vehicle for absorbing solar energy and converting same into electric energy. The electric energy is stored in the internal battery for providing power therefrom. The solar panels can be flexible, printed and can be attached using a fastening means such as an adhesive, magnetic fasteners, mounting rails, and more.

### CROSS-REFERENCE TO RELATED APPLICATION

The present application claims priority to, and the benefit of, U.S. Provisional Application No. 63/285,703, which was filed on Dec. 3, 2021 and is incorporated herein by reference in its entirety.

### FIELD OF THE INVENTION

The present invention relates generally to the field of electric vehicle (EV) charging systems. More specifically, the present invention relates to a novel photovoltaic charging system configured to be integrated or retrofitted to an electric vehicle and is used to charge an internal battery system of the vehicle. The system includes a set of solar panels disposed on an exterior surface of the vehicle and is coupled to the battery via a power bus/internal wiring. The system can be used with cars, trucks, airplanes, marine crafts, and more. Accordingly, the present disclosure makes specific reference thereto. Nonetheless, it is to be appreciated that aspects of the present invention are also equally applicable to other like applications, devices, and methods of manufacture.

### BACKGROUND

By way of background, the initial versions of the electric vehicles were introduced in the 1990's, however, adoption of electric vehicles did not pick up due to limited driving range of these vehicles, lack of infrastructure for charging electric vehicles and high cost of electricity. Conventional batteries could only provide electric power for a limited range which was a major issue for adoption of these vehicles. Individuals wanted to switch from conventional gas vehicles to electric vehicles in order to reduce dependence upon non-renewable sources of energy and to promote environmental concerns, however, lack of charging stations and range issues force individuals either to stick to their conventional vehicles or drive their electric vehicles only for short distances.

Improving charging availability and speed, while also improving range issues of electric vehicles is also necessary as oil/gas as an option for vehicles is likely to cease in the next 30-40 years. Electric vehicles will provide a system for solving shortage of petroleum.

Operating costs of electric vehicles (EVs) is large which is primarily driven by cost of charging the car. Individuals are required to frequently recharge the electric battery of their electric vehicles to increase the range of their vehicle. Consumers typically charge their electric vehicle when the vehicle is parked at work during the day, which is when peak tariff rates apply. With the launch of EVs by major automobile manufacturers, EV charge stations are being installed at malls, workplaces, and other public areas to facilitate the charging of electric vehicles, however, charging of EVs at charging stations is expensive. Individuals desire a way to cost-effectively recharge batteries of electric vehicles to increase the range of their EVs and reduce operating cost of EVs.

Therefore, there exists a long felt need in the art for a charging system that easily recharges the battery of electric vehicles. There is also a long felt need in the art for an electric vehicle charging system that supplements power used by the internal or main vehicle battery. Additionally, there is a long felt need in the art for a charging system for electric vehicles that reduces operational costs of charging an internal or main vehicle battery. Moreover, there is a long felt need in the art for a more environmentally friendly and conscious power source for electric vehicles. Further, there is a long felt need in the art for a charging system for an electric vehicle that increases range of electric vehicles. Furthermore, there is a long felt need in the art for a charging system for electric vehicles that can be integrated or retrofitted to recharge internal or main vehicle battery. Finally, there is a long felt need in the art for an environmentally friendly and cost-effective charging system for electric cars, trucks, airplanes, marine crafts, and more.

The subject matter disclosed and claimed herein, in one embodiment thereof, comprises a solar electric vehicle charging system. The system provides users with modified electric vehicles featuring solar panels integrated into the roof, trunk, and other curvature surface areas of cars, trucks, airplanes, marine crafts, and more. The system comprising a plurality of flexible solar panels integrated or removably attached to exterior surfaces of the vehicle, the solar panels consisting of a plurality of photovoltaic cells for converting absorbed solar energy into electric energy, wherein the solar panels are coupled to an internal battery of the electric vehicle via a power bus of the vehicle for supplying electric energy to the battery.

In this manner, the solar charging system of the present invention accomplishes all of the forgoing objectives and provides users with modified electric vehicles featuring solar panels. The set of solar panels that can be manufactured within new vehicles or attached to aftermarket vehicles. The solar panels are attached directly to the internal or main vehicle battery once installed or manufactured within the designated locations for providing environmentally friendly and conscious power source for electric vehicles ensuring that the vehicles do not run out of battery charge during long trips while saving costs and time related to the charging stations used for charging the internal or main vehicle battery.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar electric vehicle charging system. The system comprising at least a pair of mounting rails positioned on exterior surface of the electric vehicle, the mounting rails are configured for receiving a flexible solar panel, the solar panel consisting of a plurality of photovoltaic cells for converting absorbed solar energy into electric energy, wherein the solar panel when mounted on the rails, is coupled to an internal battery of the electric vehicle via a power bus of the vehicle for supplying electric energy to the battery.

In yet another embodiment, the solar panel produces AC electric energy.

In yet another embodiment, the system further comprising of a converter for converting AC produced by the solar panel to DC before supplying to the internal battery of the electric vehicle.

In yet another embodiment, the solar panel is connected to one or more of an external battery, HVAC system, and/or refrigeration system of the vehicle.

In yet another embodiment, a photovoltaic vehicle charging system for electric vehicle is disclosed. The charging system includes a set of solar panels configured to be manufactured or installed on an exterior surface of the electric vehicle, the solar panels are flexible and are coupled to an internal battery of the vehicle, wherein the solar panels are adhered using strong magnetic fasteners, each solar panel is of 125-250 watts and the electrical energy produced by the solar panels can be around 10-30 kWh per day.

In yet another embodiment, the solar panels are adhered to exterior surface using strong adhesive.

In yet another embodiment, the solar panels are printed panels.

In yet another embodiment, the electric vehicle is one of electric car, electric truck, airplane, marine craft, train, and more.

In yet another embodiment, a photovoltaic vehicle charging system for electric vehicle is disclosed. The charging system includes a set of solar panels configured to be retrofitted using mounting rails on an exterior surface of the aftermarket electric vehicle, the solar panels are flexible and are coupled to an internal battery of the vehicle via internal wiring of the vehicle, each solar panel is of 100-200 watts and the electrical energy produced by the solar panels can be around 20-35 kWh per day.

In yet another embodiment, a method of increasing range of electric vehicles is described. The method includes the steps of providing a photovoltaic vehicle charging system, the system including a plurality of solar panels disposed on exterior surface of an electric vehicle, the solar panels are configured to produce alternating current from solar energy; converting, by a converter, alternating current into direct current; transmitting, by a power bus, direct current to an internal battery of the vehicle; and recharging the internal battery to supplement stored electric power for providing to the electric vehicle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of an electric vehicle solar charging system of the present invention in accordance with the disclosed architecture;

FIG. 2 illustrates a perspective view of a pickup truck equipped with the solar charging system of the present invention in accordance with the disclosed architecture;

FIG. 3 illustrates a top perspective view of a solar charging system powered electric truck in accordance with the disclosed architecture;

FIGS. 4A and 4B illustrate perspective views of an electric car equipped with a solar panel attached to top surface for providing electric power to main battery in accordance with the disclosed architecture;

FIG. 5 illustrates a perspective view of an airplane equipped with solar panels of the photovoltaic vehicle charging system of the present invention in accordance with the disclosed architecture; and

FIG. 6 illustrates a perspective view of a yacht equipped with solar panels of the photovoltaic vehicle charging system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a charging system that easily recharges the battery of electric vehicles. There is also a long felt need in the art for an electric vehicle charging system that supplements power used by the internal or main vehicle battery. Additionally, there is a long felt need in the art for a charging system for electric vehicles that reduces operational costs of charging an internal or main vehicle battery. Moreover, there is a long felt need in the art for a more environmentally friendly and conscious power source for electric vehicles. Further, there is a long felt need in the art for a charging system for an electric vehicle that increases range of electric vehicles. Furthermore, there is a long felt need in the art for a charging system for electric vehicles that can be integrated or retrofitted to recharge internal or main vehicle battery. Finally, there is a long felt need in the art for an environmentally friendly and cost-effective charging system for electric cars, trucks, airplanes, marine crafts, and more.

The present invention, in one exemplary embodiment, is a novel photovoltaic vehicle charging system for electric vehicle. The charging system includes a set of solar panels configured to be integrated or retrofitted using a fastening means on exterior surface of the electric vehicle, the solar panels are coupled to an internal battery of the vehicle via internal wiring of the vehicle, each solar panel is of 100-200 watts and the electrical energy produced by the solar panels can be around 20-35 kWh per day.

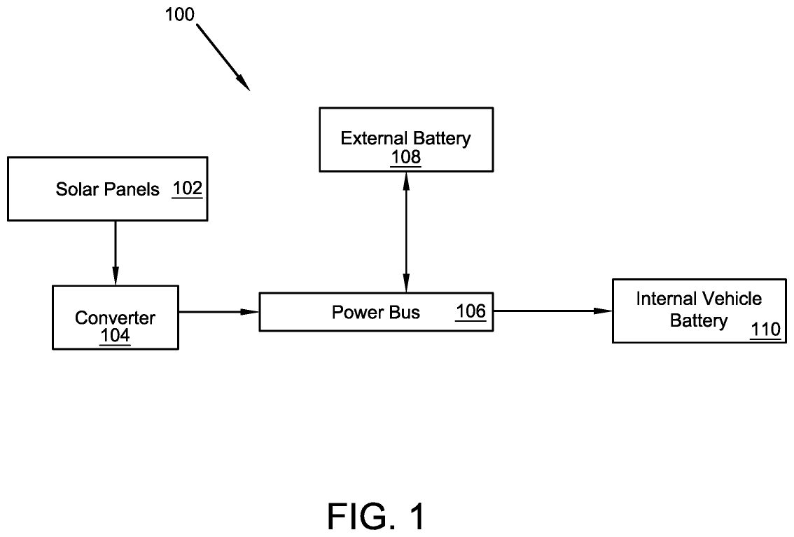

Referring initially to the drawings, FIG. 1 illustrates a schematic view of one potential embodiment of electric vehicles solar charging system of the present invention in accordance with the disclosed architecture. The electric vehicles solar charging system 100 of the present invention consists of a set of solar panels 102 that are manufactured within new electric vehicles or attached to aftermarket electric vehicles. The solar panels 102 can be permanently or removably installed on roofs, trunks, and other curvature areas of any type of electric vehicle to provide supplemental power to the internal or main vehicle battery 110.

The solar panels 102 are passive vehicle sources and includes a plurality of photovoltaic cells for absorbing solar energy and converting the solar energy into electrical energy. Each solar panel 102 used in the solar charging system 100 of the present invention is designed based on the curvature and design of electric vehicle and can be in the range of about 125-250 watts. The electrical energy produced by each solar panel can be around 10-30 kWh of alternating current (AC) per day. The solar panels 102 are light, robust, and cost-efficient modules and include a thickness of about 5 mm.

The electricity produced by solar panels 102 is fed into a converter 104 that converts the alternating current into direct current (DC). The converter 104 is designed not to waste energy during conversion ensuring maximum electric energy is passed onto the power bus 106 of the electric vehicle. The power bus 106 provides full electrical/electronic (E/E) integration for charging the main battery/internal or main vehicle battery 110. The DC energy from the converter 104 supplements the internal or main vehicle battery 110 and thus, the solar charging system 100 helps in increasing the range of the electric vehicle and reduces requirement of frequent charging of the internal battery 110.

In the present embodiment, an external battery 108 is included in the system 100 for storing the electric energy produced by the solar panels 102. The external battery 108 can be recharged in cases where the main battery 110 is fully charged and cannot accumulate any additional electric power. The power bus 108 can automatically recharge the external battery 108 in case the main battery 110 is fully charged. The power bus 106 and the main battery 110 can be internal parts of the vehicle and can be connected to the system 100.

The system 100 can be either a retrofit solution, or an embedded system which is built-in within the chassis of an electric vehicle itself. The photovoltaic panels 102 are installed in order to increase the power generated by the system. The system 100 provides cost-effective and environment-friendly power generation mechanism that can be used whenever the vehicle is outdoors for producing electric power.

It should be noted that the panels 102 can be conventional lightweight panels or alternatively can be printed panels. The solar panels 102 can be mounted to the vehicles using mounting rails, fasteners, adhesive or any other fastening mechanism known in the art.

The advantage of the solar charging system 100 is that when sunlight strikes on solar panels 102, the panels 102 convert the energy into electricity. As the sun is an energy source that is available throughout the world, it is particularly well-suited as an energy source for recharging electric vehicle. An electric vehicle can be equipped with as many solar panels as the physical structure of the vehicle can support as per design of the system.

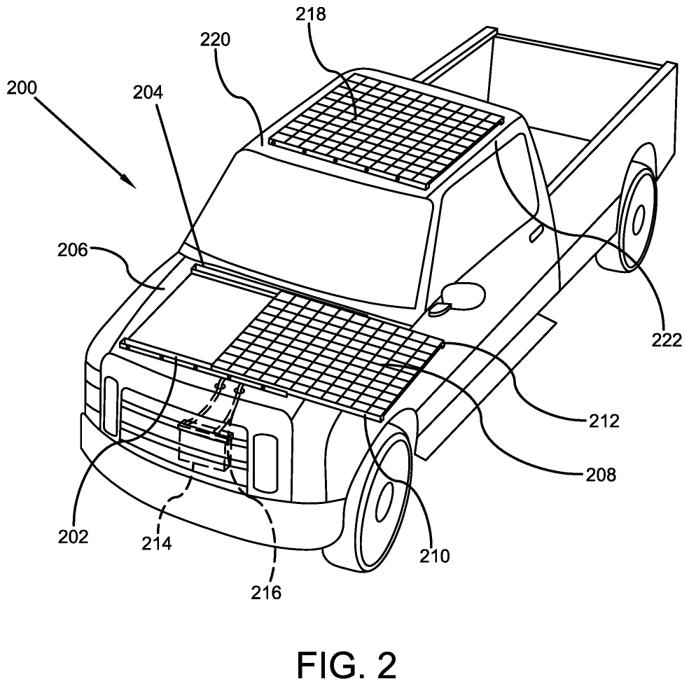

FIG. 2 illustrates a perspective view of a pickup truck equipped with the solar charging system of the present invention in accordance with the disclosed architecture. In the present embodiment, the pickup truck 200 has a pair of mounting rails 202, 204 positioned on the hood 206. The mounting rails 202, 204 are used for receiving and securing a flexible solar panel 208 such that the longitudinal edge 210 is locked in the rail 202 and the other longitudinal edge 212 is locked in the rail 204 for accommodating the solar panel 208.

Once the solar panel 208 is accommodated in the rails 202, 204, the electrical power produced by photovoltaic cells of the solar panel 208 is trickled to internal or main vehicle battery 214 of the pickup truck 200. The rails 202, 204 are configured to provide electrical connection to the battery 214 using the power bus/circuit 216. The solar panel 208 continuously absorbs the solar energy falling thereon to convert into electrical energy for supplementing power in the battery 214.

It should be noted that the rails 202, 204 can be retrofitted as an aftermarket product for existing vehicles in which the solar panel 208 can be accommodated. Similarly, depending on design of the pickup truck 200, an additional solar panel 218 can be integrated or removably attached to the top surface 220 of the cabin 222 of the truck 200.

Although, solar panels on only hood 206 and cabin 222 are shown in the present embodiment, it should be appreciated that any number and configuration of solar panels can be attached to the truck bed and other areas of the truck 200 for an effective capture of solar light and conversion into electrical energy.

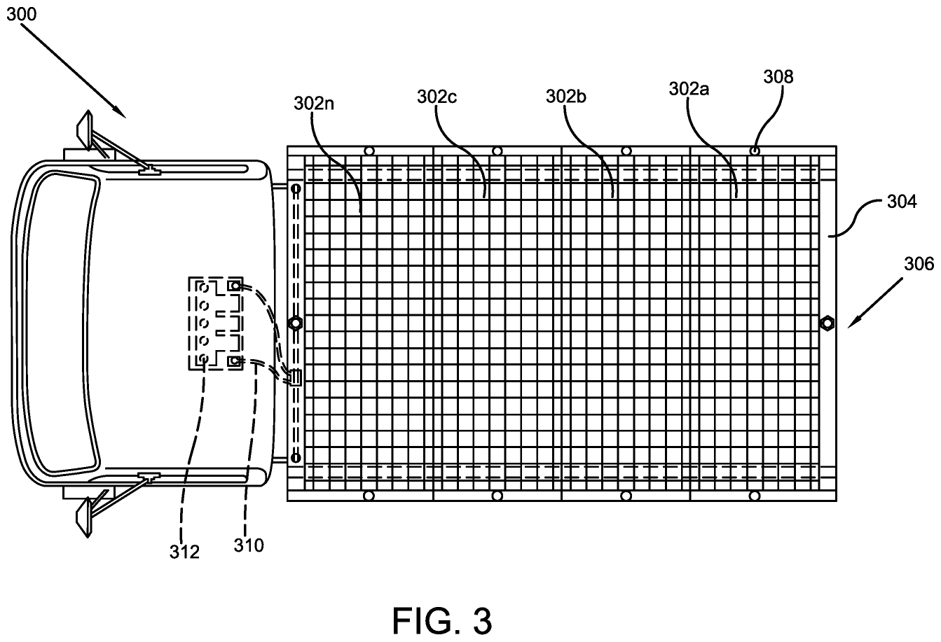

FIG. 3 illustrates a top perspective view of a solar charging system powered electric truck 300 (i.e. tractor trailer truck combination) in accordance with the disclosed architecture. In the present embodiment, the tractor trailer truck 300 has a plurality of serially coupled solar panels 302a-n positioned on top surface 304 of the trailer 306 of the truck 300. Each of the solar panels 302a-n is fastened to the top surface 304 using fasteners 308 allowing the panels 302a-n to be secured even when the truck 300 runs at a very high speed. A common wire/power bus 310 connects the serially coupled solar panels 302a-n to an internal battery 312 of the truck 300.

The internal battery 312 continuously receives electric power produced by the solar panels 302a-n from conversion of captured solar energy for providing power to the truck 300. In cases where any of the solar panels are required to be replaced, the solar panel can be removed by opening the corresponding fasteners.

It should be appreciated that the solar panels can be used for providing direct electric supply to an HVAC system, a refrigeration system, or any other module of the truck 300 without directly supplying electric power to main battery 312 of the truck 300 as per preferences of truck manufacturers and users.

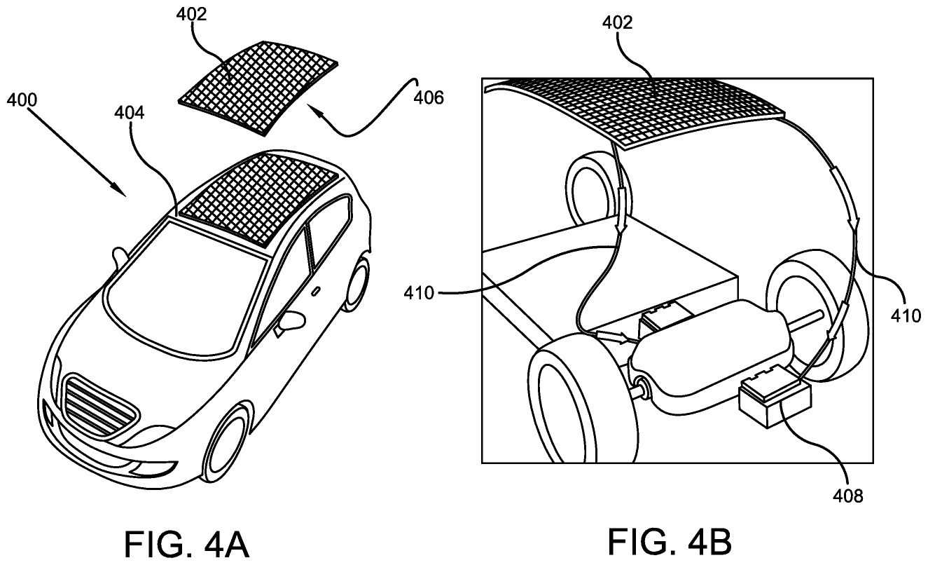

FIGS. 4A and 4B illustrate perspective views of an electric car equipped with a solar panel attached to a top surface for providing electric power to the main battery in accordance with the disclosed architecture. As illustrated in FIG. 4A, a flexible solar panel 402 is attached to roof 404 of the electric car 400 using an attachment means like an adhesive layer. The adhesive layer may be disposed on the rear surface 406 of the solar panel 402 and can be used for attaching the solar panel 402 on the roof 404.

As illustrated in FIG. 4B, the solar panel 402 is coupled to the main battery 408 of the car 400 through internal wires 410 of the car 400. The electric energy produced by the panel 402 is stored in the main battery 408 and as a result, frequency of charging the battery 408 on charging stations is reduced while increasing range of the car 400.

The wires 410 are positioned inside the car 400 and are not visible from outside, thereby maintaining aesthetic appeal of the car 400. Further, the wires 410 can be connected to a new solar panel when the existing solar panel is replaced with a new one.

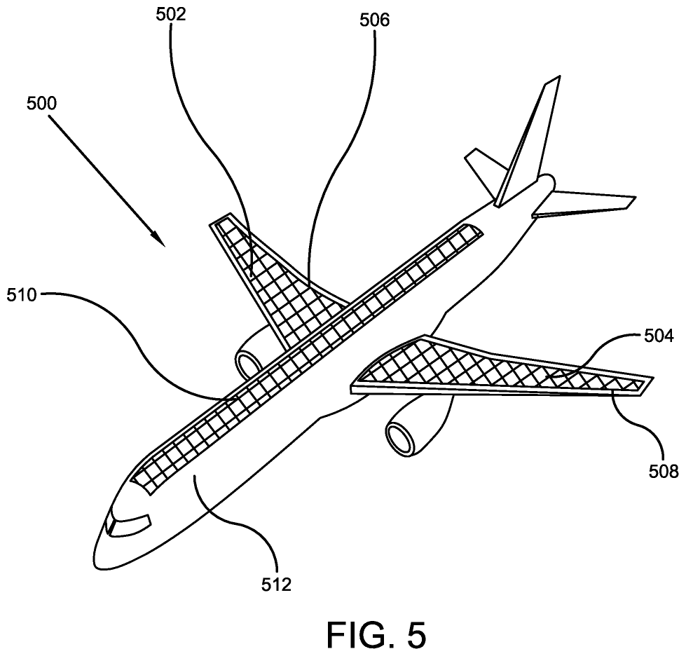

FIG. 5 illustrates a perspective view of an airplane equipped with solar panels of the photovoltaic vehicle charging system of the present invention in accordance with the disclosed architecture. In the present embodiment, the airplane 500 is equipped with solar panels 502, 504 on the wings 506, 508 respectively for absorbing solar energy and converting into electric power. Similarly, a third solar panel 510 is positioned on the cabin 512 of the airplane.

The internal and one or more external batteries (not shown) of the airplane 500 are coupled to the solar panels 502, 504, 510 for recharging the batteries and thus providing supplemental power for the airplane 500.

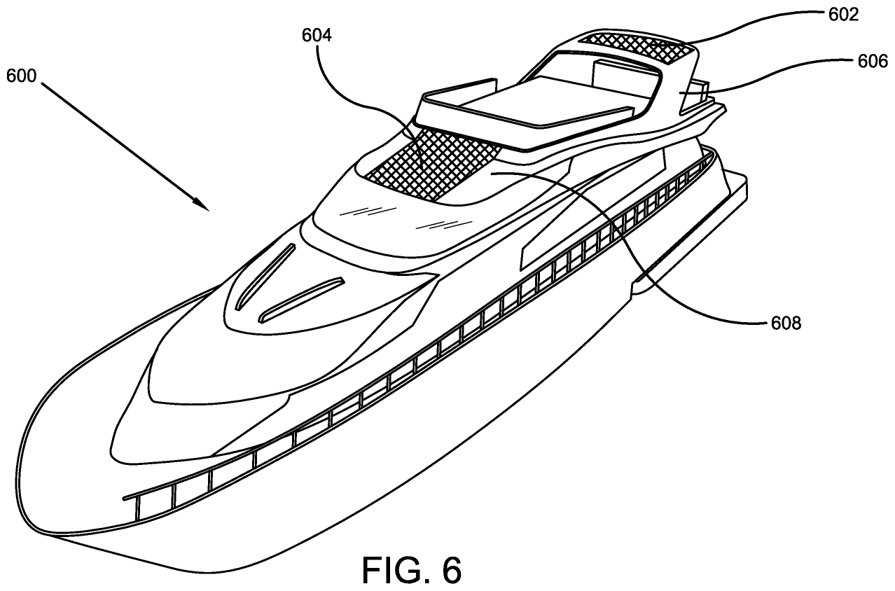

FIG. 6 illustrates a perspective view of a yacht (i.e. boat) equipped with solar panels of the photovoltaic vehicle charging system of the present invention in accordance with the disclosed architecture. In the present embodiment, the yacht 600 is equipped with solar panels 602, 604 on the stern 606 and hatch 608 respectively for absorbing solar energy and converting same into electric power. Similarly, any number of solar panels conforming to the shape and size of the yacht can be positioned for absorbing solar energy and converting into the electric energy.

The solar charging system of various embodiments of the present invention increases the range of the vehicle by supplementing electric power of the battery and reduces frequency of visits to charging stations. The system offers a more environmentally friendly and conscious power source for vehicles, thereby replacing excessive use of fossil fuels.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “solar electric vehicle charging system”, “photovoltaic vehicle charging system”, “electric vehicles solar charging system”, “charging system”, and “system” are interchangeable and refer to the photovoltaic electric vehicle charging system 100 of the present invention.

Notwithstanding the forgoing, the photovoltaic electric vehicle charging system 100 of the present invention can be of any suitable size and configuration as is known in the art without affecting the overall concept of the invention, provided that it accomplishes the above stated objectives. One of ordinary skill in the art will appreciate that the photovoltaic electric vehicle charging system 100 as shown in the FIGS. are for illustrative purposes only, and that many other sizes and shapes of the photovoltaic electric vehicle charging system 100 are well within the scope of the present disclosure. Although the dimensions of the photovoltaic electric vehicle charging system 100 are important design parameters for user convenience, the photovoltaic electric vehicle charging system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle solar charging system comprising:
a plurality of solar panels;
a plurality photovoltaic cells for absorbing a solar energy;
a converter for converting the solar energy into an electrical energy;
a power bus for receiving said electrical energy;
wherein said electrical energy converted from the solar energy is stored in a main battery of a vehicle;
wherein said electrical energy converted from the solar energy is stored in an auxiliary battery of said vehicle;
wherein each of said plurality of solar panels is flexible; and
further wherein said electrical energy produced by each of said plurality of solar panels is from about 10 kWh to about 30 kWh of alternating current per day.

2. The vehicle solar charging system of claim 1, wherein said converter converts said electrical energy from an alternating current to a direct current.

3. The vehicle solar charging system of claim 2, wherein said direct current supplements a charge of said main battery of said vehicle.

4. The vehicle solar charging system of claim 3, wherein said power bus charges said auxiliary battery of said vehicle after said main battery is fully charged.

5. The vehicle solar charging system of claim 4, wherein said vehicle comprises a first mounting rail and a second mounting rail positioned on a hood of said vehicle, and further wherein at least one solar panel is received between said first and said second mounting rails.

6. The vehicle solar charging system of claim 4, wherein said power bus trickles said electrical energy to said main battery of said vehicle.

7. The vehicle solar charging system of claim 6, wherein said vehicle comprises at least another flexible solar panel removably attached to a top surface of a cabin of said vehicle.

8. The vehicle solar charging system of claim 4, wherein said vehicle is an airplane, and further wherein said airplane comprises a plurality of flexible solar panels attached to a cabin and to a pair of wings of said airplane.

9. The vehicle solar charging system of claim 4, wherein said vehicle is a boat, and further wherein said boat comprises a plurality of flexible solar panels attached to a stern and a hatch of said boat.

10. The vehicle solar charging system of claim 4, wherein said vehicle is a tractor trailer, and further wherein said tractor trailer comprises a plurality of flexible solar panels attached to a top surface of a trailer of said tractor trailer.

11. The vehicle solar charging system of claim 4, wherein said vehicle comprises at least one solar panel having an adhesive layer disposed on a rear surface for adhesively attaching said at least one solar panel to a roof of said vehicle.

12. A vehicle solar charging system comprising:
a plurality of solar panels;
a plurality photovoltaic cells for absorbing a solar energy;
a converter for converting the solar energy into an electrical energy;
a power bus for receiving said electrical energy;
wherein said electrical energy converted from the solar energy is stored in a main battery of said vehicle;
wherein said electrical energy converted from the solar energy is stored in an auxiliary battery of said vehicle;
wherein each of said plurality of solar panels is flexible;
wherein said converter converts said electrical energy from an alternating current to a direct current;
wherein said direct current supplements a charge of said main battery of said vehicle; and
further wherein said power bus charges said auxiliary battery of said vehicle after said main battery is fully charged.

13. The vehicle solar charging system of claim 12, wherein said electrical energy produced by each of said plurality of solar panels is from about 10 kWh to about 30 kWh of alternating current per day.

14. The vehicle solar charging system of claim 13, wherein said vehicle comprises a first mounting rail and a second mounting rail positioned on a hood of said vehicle, and further wherein at least one of the plurality of solar panels is positioned between said first and said second mounting rails.

15. The vehicle solar charging system of claim 14, wherein said power bus trickles said electrical energy to said main battery of said vehicle.

16. The vehicle solar charging system of claim 14, wherein said vehicle includes at least another flexible solar panel removably attached to a top surface of a cabin of said vehicle.

17. The vehicle solar charging system of claim 13, wherein said vehicle is an airplane, and further wherein said airplane comprises a plurality of flexible solar panels attached to a cabin and to a pair of wings of said airplane.

18. The vehicle solar charging system of claim 13, wherein said vehicle is a boat and further wherein said boat comprises a plurality of flexible solar panels attached to a stern and a hatch of said boat.

19. The vehicle solar charging system of claim 13, wherein said vehicle is a tractor trailer, and further wherein said tractor trailer comprises a plurality of flexible solar panels attached to a top surface of a trailer of said tractor trailer.

20. A vehicle solar charging system comprising:
a plurality of solar panels;
a plurality photovoltaic cells for absorbing a solar energy;
a converter for converting the solar energy into an electrical energy;
a power bus for receiving said electrical energy;
wherein said electrical energy converted from the solar energy is stored in a main battery of said vehicle;
wherein said electrical energy converted from the solar energy is stored in an auxiliary battery of said vehicle after the main battery is fully charged;
wherein each of said plurality of solar panels is flexible;
wherein said converter converts said electrical energy from an alternating current to a direct current;
wherein said direct current supplements a charge of said main battery;
wherein said electrical energy produced by each of said plurality of solar panels is from about 10 kWh to about 30 kWh of alternating current per day; and
further wherein said vehicle includes at least one solar panel having an adhesive layer disposed on a rear surface for adhesively attaching said at least one solar panel to a roof of said vehicle.
